(19) United States
(12) Patent Application Publication
(10) Pub. No.: US 2005/0271787 A1
(43) Pub. Date: Dec. 8, 2005

(54) High protein, low carbohydrate pasta

(75) Inventors: Dustin Theodore Doud, Clinton, WI (US); Jack William Maegli, Beloit, WI (US); Peter Murray, Shellsburg, IA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Kerry Group Services International, Co. Kerry (IE)

(21) Appl. No.: 10/858,603

(22) Filed: Jun. 2, 2004

(51) Int. Cl. A23L 1/00

(52) U.S. Cl. 426/557

(57) ABSTRACT

The present invention provides high protein, low carbohydrate pastas that are also low in fiber. Specifically, a pasta comprising, by weight, at least about 55% protein, about 10% or less fiber, and at least about 4% fat is provided. The pastas also comprise less than about 30% total carbohydrate by weight. The pastas provided herein include a rapid-cook pasta, a rice substitute, a gluten-free pasta, and a soy-milk based pasta. The present invention further provides a pasta having at least about 55% protein, by weight, and having a firmness value that does not differ by more than 40% from that of 100% durum semolina wheat pasta. Also, the present invention provides food compositions from which the pastas are made. Further provided are farinaceous food products, including, but not limited to, pastas, made from the food compositions provided herein.

### FIELD OF THE INVENTION

This invention relates to high protein, low carbohydrate pastas, food compositions related thereto, and farinaceous food products made therefrom.

### BACKGROUND OF THE INVENTION

High protein, low carbohydrate pastas for purposes of nutritional fortification or compliance to specific dietary regimens are known in the art (see, for example, U.S. Pat. Nos. 3,949,101; 4,000,330; 4,120,989; and 6,322,826; and U.S. patent application No. 2002/0155206). However, such pastas have high amounts of dietary fiber, such that the texture of the cooked pasta is not similar to that of a traditional semolina-based pasta. Instead, these high protein, high fiber, low carbohydrate pastas have a firm, dry, abrasive texture that makes it less desirable to eat. Some protein-based pastas, which have extremely low amounts of fiber, have a continuous protein network. These pastas tend to be defectively firm, chewy, and rubbery in texture. Also, such high protein pastas require longer cook times in order for the pastas to soften. Moreover, the pastas of the prior art are often difficult to produce, as they are made from doughs that are sticky, firm, and prone to die obstruction, which limits the efficiency with which they can be produced with large scale manufacturing extruders. Furthermore, some high protein, low carbohydrate pastas are not stable in acidic sauces or dressings, such that they cannot be used in tomato-based sauces or vinegar-based dressings. Instead, these pastas curdle in acidic environments, thereby rendering them less palatable.

In view of the foregoing, there is a need in the art for high protein, low carbohydrate pastas having a desirable texture, e.g., a texture that is similar to that of traditional pastas, that have a cook time that is similar to that of traditional pastas, and that are stable in acidic environments, such as tomato-based sauces and vinegar-based dressings. There is also a need for pastas having higher amounts of protein and lower amounts of carbohydrates than pastas known in the art, and for pastas that are suitable for manufacture with single-screw extruders or twin-screw extruders, or for manufacture in a home kitchen.

The present invention provides improved pastas. These and other advantages of the invention, as well as additional inventive features, will be apparent from the description of the invention provided herein.

### BRIEF SUMMARY OF THE INVENTION

The present invention provides high protein, low carbohydrate pastas that are also low in fiber. Specifically, a pasta comprising, by weight, at least about 55% protein, about 10% or less fiber, and at least about 4% fat is provided. The pastas also comprise less than about 30% total carbohydrate by weight. The pastas described herein include a rapid-cook pasta, a rice substitute, a gluten-free pasta, and a soy-milk based pasta. Such pastas differ from other high protein, low carbohydrate pastas of the prior art by having nearly the same properties of traditional semolina pastas with respect to manufacturing, home use, taste, and texture. The present invention also provides a pasta having at least about 55% protein, by weight, and having a firmness value that does not differ by more than 40% from that of 100% durum semolina wheat pasta.

The present invention also provides food compositions from which the pastas are made. In particular, the present invention provides a food composition comprising (i) about 10-20% glutinous protein, (ii) about 35-80% globular protein, (iii) starch, fat, or combinations thereof, and, optionally, (iii) buffering agent. Further provided are farinaceous food products, including, but not limited to, pastas, made from the food compositions described herein.

### BRIEF DESCRIPTION OF THE DRAWINGS

FIG. 1 illustrates the textural stability of pastas containing or lacking semolina. The x-axis is the semolina leverage (range: 0 to 5). The y-axis is textural stability leverage (range: 0 to 5), which is acid peak bite force (pH˜2) divided by neutral peak bite force residual (pH˜6.5). P=0.0005

FIG. 2 illustrates the textural stability of pastas with or without added finely emulsified fat. The x-axis is fat leverage (range: 1 to 35). The y-axis is textural stability leverage residual (range: 0 to 5) as described for FIG. 1. P=0.0151.

FIG. 3 illustrates the textural stability of pastas having different globular proteins. The x-axis is protein selection leverage (range: 1.5 to 3.5). The y-axis is textural stability residual (range 0 to 5), as described for FIG. 1. P=0.0760.

### DETAILED DESCRIPTION OF THE INVENTION

The present invention provides high protein, low carbohydrate pastas that are also low in fiber. Specifically, a pasta comprising, by weight, at least about 55% protein, about 10% or less fiber, and at least about 4% fat is provided. The pasta of the present invention desirably comprises less than about 30% total carbohydrate by weight. Preferably, the pasta comprises less than about 15% total carbohydrate by weight. Pasta in accordance with one embodiment of the invention comprises, by weight, about 55-75% protein, about 10-30% total carbohydrate, about 3-10% fiber, and about 4-10% fat.

In a preferred embodiment of the present invention, pasta comprises, by weight, about 58% protein, about 27% total carbohydrate, about 4% fiber, and about 6% fat. In another preferred embodiment, pasta comprises, by weight, about 69% protein, about 13% total carbohydrate, about 6% fiber, and about 5% fat. In another preferred embodiment, pasta comprises, by weight, about 72% protein, about 12% total carbohydrate, about 7% fiber, and about 8% fat.

The pasta of the present invention can be a high protein, low carbohydrate rice substitute. The term “rice substitute” as used herein refers to a pasta that has properties similar to rice, including, for example, shape, size, texture, etc. The rice substitute comprises, by weight, at least about 55% protein, about 12% or less fiber, and at least about 4% fat. Preferably, the rice substitute comprises, by weight, at least about 65% protein and less than about 20% total carbohydrate. More preferably, the rice substitute comprises, by weight, about 65% protein, about 14% total carbohydrate, about 6% fiber, and about 7% fat. Also preferred is a rice substitute comprising, by weight, about 68% protein, about 16% total carbohydrate, about 10% fiber, and about 5% fat.

The pasta of the present invention can also be a gluten-free pasta. By “gluten-free” as used herein is meant that the pasta is substantially devoid of gluten. Gluten is a mixture of plant proteins occurring in cereal grains, chiefly corn and wheat, used as an adhesive and as a flour substitute. It may be separated from the flour of grain by subjecting the flour to a current of water, such that the starch and other soluble matters are washed out. Individuals having an allergy to gluten can enjoy the pasta of the present invention. The gluten-free pasta of the present invention comprises, by weight, at least about 75% protein and less than about 10% total carbohydrate. Preferably, the gluten-free pasta comprises, by weight, about 80% protein, about 7% total carbohydrate, less than 5% fiber, and about 7% fat.

Alternatively, the pasta of the present invention can be a rapid-cook pasta. The term “rapid-cook” as used herein refers to a pasta having a shorter cook time than a pasta that is not a rapid-cook pasta. A rapid-cook pasta, for example, can cook in about two thirds of the time needed to cook a traditional pasta. The rapid-cook pasta comprises, by weight, about 55% or more protein and less than about 30% total carbohydrate. Preferably, the rapid-cook pasta comprises, by weight, about 55-70% protein, about 10-30% total carbohydrate, about 3-6% fiber, and about 6-10% fat. In a preferred embodiment, the rapid-cook pasta comprises, by weight, about 55% protein, 26% total carbohydrate, about 3% fiber, and about 10% fat. In another preferred embodiment, the rapid-cook pasta comprises, by weight, about 70% protein, about 11 % total carbohydrate, about 4% fiber, and about 9% fat.

A pasta made from a food composition comprising soy milk powder, such as, a soy milk-based pasta, is also provided by the present invention. The soy milk-based pasta preferably comprises, by weight, about 48% protein, about 31% total carbohydrate, about 3% fiber, and about 6% fat. Preferably, the soy milk-based pasta is made from a food composition comprising, by weight, about 40% or more soy milk powder. More preferably, the food composition from which the soy milk-based pasta is made comprises, by weight, about 40-85% soy milk powder, 10-20% wheat gluten isolate, and about 30% or less semolina flour. Most preferably, the food composition comprises, by weight, about 65% soy milk, about 15% wheat gluten isolate, and about 20% semolina flour.

The pastas described herein are different from other high protein, low carbohydrate pastas in that they are similar to traditional semolina-based pasta with respect to texture, taste, home use, and manufacturing. Unlike other high protein pastas, the pastas provided herein boil like a traditional semolina wheat pasta, cooking in roughly the same amount of time. The present inventive pastas do not require an extended cooking time in order to have the same bite or texture as traditional semolina wheat pasta. Also, the pastas do not produce excessive foam and boil over when cooked.

Furthermore, the pastas of the present invention have a firmness that is similar to the firmness of 100% durum semolina wheat pasta, unlike other high protein pastas. Thus, the present invention provides a pasta having at least about 55% protein, by weight, and having a firmness value that does not differ by more than 40% from that of 100% durum semolina wheat pasta. Preferably, the pasta has a firmness value that does not differ by more than 25% from that of 100% durum semolina wheat pasta. More preferably, the pasta has a firmness value that does not differ by more than 10% from that of 100% durum semolina wheat pasta. Most preferably, the firmness value of the pasta does not differ by more than 5% from that of 100% durum semolina wheat pasta. Firmness value is associated with the texture of the pasta and the “feel” it has in the mouth. The pastas described herein were measure by the American Association of Cereal Chemists, Inc. (AACC) Method 16-50 (Approved Methods of the American Association of Cereal Chemists, Ninth Edition, March 1995, American Association of Cereal Chemists, Inc, St. Paul, Minn. (612) 454 7250), a variant of which is described herein as Example 5.

The pastas of the present invention can be of any size or shape. The pasta can be, for instance, a long noodle, such as spaghetti, linguini, lasagna, or angel hair. Alternatively, the pasta can be a short pasta, such as elbow macaroni, shell, bow tie, tube, or cork screw. The pasta can be used to make a filled pasta, such as a tortellini, a ravioli, gnocci, pierogi, or wonton. The pastas of the present invention can be used with a variety of dressings or sauces. For instance, pasta in accordance with the invention can be eaten with tomato-based sauce, vinegar-based dressing, cheese-based sauce, cream-based sauce, or pesto.

One of ordinary skill in the art will appreciate that the pastas of the present invention are suitable for marketing as any type of pasta. For example, the pastas described herein can be a dry pasta, marketed and sold in a box. The pastas of the present invention, for example, can be a refrigerated, ready-to-eat pasta or a canned, ready-to-eat pasta that is prepared in a sauce or a soup. Pastas in accordance with the invention can also be included in a salad, such as a macaroni salad and marketed as such.

Pastas of the present invention can be made using methods that are known in the art. The pastas can be made in a home kitchen or a commercial kitchen. When the pastas are made in a home kitchen, the dough of the pasta can be made in a countertop appliance food mixer, such as a KitchenAid® stand mixer. When the pastas are made in a commercial kitchen, the dough of the pasta can be made in either a single-screw extruder or a twin-screw extruder. Once the dough is formed, the dough is cut into pasta shapes, e.g., elbow macaroni, shells, bow tie, cork screws, linguine, spaghetti, etc. For instance, the dough can be shaped by first flattening it into a sheet with a rolling pin and then cut into long strips to make linguini or spaghetti. Alternatively, the dough can be shaped by using a pasta maker, such as the Imperia pasta maker or the KitchenAid® pasta attachment, which requires the KitchenAid® stand mixer for use. These methods of making pasta are further described herein as Examples 1-3.

The present invention also provides food compositions from which the present inventive pastas are made. The term “food composition” as used herein refers to a substantially dry mixture of components that can be used to produce a food product. One such inventive food composition comprises, by weight, (i) about 10-20% glutinous protein, (ii) about 35-80% globular protein, (iii) starch, fat, or a combination thereof, and, optionally, (iv) buffering agent.

With respect to the present invention, the term “glutinous” as used herein refers to viscid, tenacious proteins, or substance(s) thereof, which give(s) adhesiveness to dough, allowing it to be a smooth, single, stretchy matrix. The glutinous protein can be a casein protein (e.g., a sodium caseinate) or a protein derived from a cereal grain. The protein derived from a cereal grain can be a wheat gluten, which is the glutinous protein normally used in traditional pastas. It is preferable that the glutinous protein is a wheat gluten. More preferably, the wheat gluten is wheat gluten that has been treated with lactic acid. Treated wheat gluten absorbs water better than untreated wheat gluten.

The term “globular” as used herein refers to a protein that is colloidal and relatively inert. Globular protein can be soy protein, whey protein, lupin protein, or cooked, denatured and microparticulated protein of some other type. Not wishing to be bound to any particular theory, the selection of the globular protein appears to have an important influence on acid stability, cook time, and texture of the finished pasta product. Globular protein should be selected based on taste, low water binding capacity, and low solubility in boiling water. Preferably, globular protein is a soy protein. Soy protein can be a soy protein that is derived from expeller pressed flour.

The fat of the food composition described herein refers to any of various soft, solid, or semisolid organic compounds constituting the esters of glycerol and fatty acids and their associated organic groups. Fat includes any of the group of oily substances of natural occurrence, as butter, lard, tallow, etc. Fat can be, for instance, solidified animal oil or vegetable oil. The fat can be a finely divided fat, such as that bound to expeller pressed soy flour and protein derived therefrom. The term “finely divided” as used herein refers to fat that is colloidal but not necessarily in the form of a true emulsion. Emulsified fat, such as that present in soy milk, can also be used in the inventive composition. The term “emulsified fat” as used herein refers to that containing specific surfactants to support the emulsion. Emulsified fats are known in the art. The fat can be a combination of a finely divided fat or an emulsified fat. Preferably, the fat is encapsulated spray-dried fat, emulsified plastic shortening, a protein-bound oil, or a combination thereof.

Not wishing to be bound to any particular theory, the fat in the food compositions described herein reduces the friction during the extrusion step of the pasta manufacturing process. The fat also reduces the rubbery bite that is characteristic of glutenous high protein foods, perhaps by disruption of the protein network. The fat also lessens the textural changes in acidic conditions, e.g., tomato-based sauces, and the fat reduces the stickiness of pasta that improves the eating quality of the pasta.

The food compositions of the present invention can optionally comprise a buffering agent. The term “buffering agent” as used herein is a substance that minimizes change in the acidity of a solution when an acid or base is added to a solution. Examples of suitable buffering agents include calcium gluconate, lysine, citrate salt, phosphate salt, ethylendiamminetetraacetic acid, tris hydroxymethylaminoethane (TRIS buffer), lactate salt, ascorbate salt, a salt of a long chain fatty acid, or a combination thereof. Preferably, the buffering agent comprises a citrate salt and a phosphate salt, (e.g., ammonium phosphate, monocalcium phosphate, dicalcium phosphate, sodium tripolyphosphate, tetrapotassium pyrophosphate, tripotassium phosphate). More preferably, the citrate salt is sodium citrate and the phosphate salt is dicalcium phosphate. Not wishing to be bound to any particular theory, the addition of buffering agents extends the cook time so that the pastas have cook times similar to cook times of traditional pastas.

Starch included in the inventive composition can be any complex carbohydrate found chiefly in seeds, fruits, tubers, roots and stem pith of plants, notably in corn, potatoes, wheat, and rice. Starch can be a flour, preferably wheat flour, corn flour, potato flour, rice flour, or tapioca flour. Not wishing to be bound to any particular theory, the flour of the food compositions described herein balances proper pasta extrusion during manufacture of the pasta and desirable texture and acid stability after cooking the pasta. Soy and wheat flours seem to enhance the textural stability in acidic conditions, perhaps by disruption of the protein network and addition of inert bulk that resists changes in the dough's structural matrix. Starch reduces extrusion friction and improves thixotropic die flow. Furthermore, the use of flour in the food compositions of the present invention reduces the cost of making the pastas, since refined proteins are more expensive. Surprisingly, it has been found that the amount of flour used in the present inventive food compositions is inversely related to the amount of fat needed for a desirable texture.

Preferably, the food composition of the present invention comprises, by weight, about 5-55% starch, about 4% or more fat, or a combination thereof. More preferably, the food composition comprises, by weight, about 8-30% starch, about 4-16% fat, or a combination thereof. Most preferably, when starch is present in the food composition, the food composition comprises at least about 10-20% by weight starch. The food composition of the present invention preferably comprises, by weight, about 10-20% wheat gluten, about 35-80% globular protein, about 0-1% dicalcium phosphate, and about 0-1% sodium citrate.

In a preferred eimbodiment, the food composition comprises, by weight, about 45% soy protein, about 20% soy flour, about 20% semolina flour, about 14% wheat gluten isolate, about 0.5% sodium citrate, and about 0.5% disodium phosphate. This food composition can be used to make a pasta that is believed to have the best taste and texture overall. In another preferred embodiment, the food composition comprises, by weight, about 54% soy protein, about 30% soy flour, about 15% wheat gluten isolate, about 0.5% sodium citrate, and about 0.5% disodium phosphate. This food composition can be used to make a low carbohydrate pasta.

In another preferred embodiment, the inventive food composition comprises, by weight, about 47% soy protein, about 25% soy protein concentrate, about 18% wheat gluten isolate, and about 10% cream powder. This food composition can be used to produce a rice substitute. In yet another preferred embodiment, the food composition comprises, by weight, about 44% soy isolate, about 18% soy flour, about 11 % wheat gluten isolate, about 0.5% dicalcium phosphate, about 0.5% sodium citrate, about 8% soy oil, and about 18% wheat flour. This food composition can be used to make a rapid cook pasta. In still another preferred embodiment, the food composition comprises, by weight, about 57% soy protein isolate, about 28% soy flour, and about 15% wheat gluten isolate. This food composition can be used to produce a low carbohydate pasta.

In another preferred embodiment, the food composition comprises, by weight, about 25%-50% soy protein, about 25%-50% soy flour, and about 10%-20% wheat gluten. The food composition preferably comprises, by weight, about 28% soy flour, about 27% soy protein, about 27% soy concentrate, and about 18% wheat isolate. This food composition can be used to produce a rice substitute. Alternatively, the food composition preferably comprises, by weight, about 40% soy protein concentrate, about 40% soy flour, about 18% wheat gluten isolate, and about 2% salt. This food composition can be used to make a rice substitute. Also preferred is that the food composition comprises, by weight, about 30% soy flour, about 55% soy concentrate, and about 15% wheat gluten.

A gluten free food composition comprising, by weight, about 60% soy protein isolate, about 20% milk protein isolate, about 20% whey protein concentrate, and, optionally, about 0.1 % to 0.2% transglutaminase is also provided by the present invention. Also, a food composition comprising, by weight, about 40-85% soy milk powder, 10-20% wheat gluten isolate, and about 30% or less semolina flour is provided herein. The food composition preferably comprises, by weight, about 65% soy milk, about 15% wheat gluten isolate, and about 20% semolina flour.

The present invention also provides a farinaceous food product made from any of the food compositions described herein. The term “farinaceous” as used herein refers to a food product that is made from, is rich in, or consists of starch. Farinaceous food products include, for instance, breads, pastas, doughnuts, muffms, waffles, pancakes, cakes, and the like. The food compositions have been formulated to make high protein, low carbohydrate pastas. The food product preferably is a pasta.

### EXAMPLES

The following examples further illustrate the invention but should not be construed as in any way limiting its scope.

Materials: The following materials were used to make the pastas described in the examples below: Nutriant ISO III soy protein and Nutriant Standard Flour S120 soy flour (Nutriant, Cedar Falls, Iowa); ADM Profam 974 soy protein isolate (Archer Daniels Midland Company, Decatur, Ill.); wheat gluten isolate (Midwest Grain Products Ingredients Inc., Atchison, Kans.); semolina flour (Antonie's Pasta, Fair Lawn, N.J.); and sodium citrate and dicalcium phosphate (Brenntag Great Lakes, Milwaukee, Wis.).

Analytical methods: The following methods were used to determine the nutritional values of-the formulations set forth below:

| | |
|---|---|
| % Fat | Acid hydrolysis (Method of the |
| | Association of Official Analytical |
| | Chemists (AOAC) 922.06 (Official |
| | Methods of Analysis of AOAC |
| | INTERNATIONAL, 17th Edition, |
| | Revision 1, 2002, AOAC International, |
| | Gaithersburg, MD)) |
| % Protein | Combustion (N × 6.25 Moisture Free |
| | Basis), Method AOAC 990.03 |
| % Ash | Method AACC 8-16 |
| % Moisture | Forced Air Oven (Method of the American |
| | Oil Chemists' Society (AOCS) Ba2a-38 |
| | (Official Methods and Recommended |
| | Practices of the AOCS, 5^{th} ed., AOCS |
| | Press, Champaign, IL) |
| % Total Dietary Fiber | Method AOAC 991.43 |
| % Total Carbohydrates | Calculated by substracting from 100% the |
| | sum of the percentages of protein, |
| | moisture, fat, and ash |
| Calories | Calculated in accordance with Code of |
| | Federal Regulations (CFR) 101.9 |
| | Nutritional Labeling of Food. |

The analytical methods used to determine the nutritional information for the pastas can be performed by commercial testing service providers, such as Silkier, Inc (Minnetonkae, Minn.); Silliker, Inc., (Chicago Heights, Ill.); and Medallion Labs (Minneapolis, Minn.).

Other methods: For each formulation described herein, a pasta was produced by the specified method and a variety of parameters were assessed. Taste was qualitatively tested by a small group of individuals. Texture was quantitatively measured by the method described in Example 5. Acid stability was determined by measuring the peak bite force, which is the maximum force required to break a noodle, as measured by the method of Example 5, in acidified and neutral conditions. Acid stability is the ratio of peak bite force in acidified condition to the peak bite force in neutral conditions.

### Example 1

This example illustrates a method of manufacturing pastas of the present invention using a single-screw extruder.

Traditional pasta manufacturing methods were used. Specifically, a single screw to twin screw extruder with a longer length to diameter ratio was used (approximately 20 L:D). In a single screw extruder (Defrancisi Machine), the dry blend was loaded into a loss in weight feed hopper and metered through a rotary air lock into a vacuum chamber. Water was added in the vacuum chamber to bring the total water content to 30%. The partially wet dough was then fed into the single screw extruder, in the mouth of which additional water was added bringing the total water content in the dough to 50-60%. The dough was pushed through the single screw extruder, and exited though shaped dies at approximately 55° C. A cutter could have been present for short goods like elbows or shells. The fresh protein pasta was then dried. Drying was accomplished by traditional means: 5 hours at 55° C. and 85% RH, 5 hours at 73° C. and 80% RH, 2 hour ramp down to 40° C. at 50% RH. Drying can be performed overnight. Since protein pasta is less prone to surface defects like checking, protein pasta short goods can be dried in 45 minutes at 85° C. and 15% RH in a vibrating fluid bed.

### Example 2

This example illustrates a method of manufacturing pastas of the present invention using a twin-screw extruder.

A twin-screw extruder, such as an APV MPF 40 was also used. Protein Pasta dry blend was filled into a hopper and fed by a metering screw into the mouth of the extruder. A low shear screw was used consisting of a low shear blending zone in the feed section followed by double flight forward screws through the remainer of the barrel. Water was added in the feed section bringing the dough to 40-60% total moisture. Cooling was used to maintain a barrel temperature of 20° C. or less. Dough exited the extruder through dies and was collected as short or long goods.

### Example 3

This example illustrates a method of making the present inventive pasta in a home kitchen, as opposed to a commercial kitchen.

A Kitchen-Aid mixer with a meat grinder and pasta die attachment was also used. The protein pasta was blended with water to approximately 50% water by weight in the mixing bowl. The bowl was removed and the meat grinder was attached to the KitchenAid mixer with a pasta die present at the grinder exit. A golf ball-sized dough was stuffed into the throat of the meat grinder. The single screw within the meat grinder pushed the dough out through pasta dies resulting in finished product that was cooked immediately. For dry storage prior to use, it was air dried overnight, oven dried at 200° F., or dried in a food dehydrator.

### Example 4

The following formulations illustrate pastas of the present invention.

Formulation A

This formulation illustrates a preferred embodiment of the present invention. This pasta illustrates a pasta having the best overall taste.

Formulation A comprised the following components:

| Ingredient | % by weight |
|---|---|
| Soy Protein containing fat (Nutriant Iso III) | 45 |
| Soy Flour (Nutriant Standard Flour S120) | 20 |
| Semolina Flour (Antoine's Pasta Flour) | 20 |
| Wheat gluten isolate (MGP Arise 6000) | 14 |
| Sodium Citrate | 0.5 |
| Disodium phosphate | 0.5 |

Results of Formulation A

| | |
|---|---|
| Manufacturing method | See Example 2 |
| Extrusion qualities | Desirable in low temperature, |
| | low shear pasta extrusion |
| Water injection required for pasta | 40-60% (w/w) |
| dough formation | |
| Taste and texture | Very good |
| Acid stability | Very good (+22% change) |

Nutritional Information of Formulation A per 100 g serving

| | | |
|---|---|---|
| Protein | 58 | g |
| Total Carbohydrate | 27 | g |
| Fiber | 4 | g |
| Fat | 6 | g |
| Calories | 377 | calories |

Formulation B

This formulation illustrates flour composition without added fats.

Formulation B comprised the following components:

| Ingredient | % by weight |
|---|---|
| Soy Protein - fat free (ADM Profam 974) | 45 |
| Soy Flour (Nutriant Standard Flour S120) | 20 |
| Semolina Flour (Antoine's Pasta Flour) | 20 |
| Wheat gluten isolate (MGP Arise 6000) | 14 |
| Sodium Citrate | 0.5 |
| Disodium phosphate | 0.5 |

Results of Formulation B

| | |
|---|---|
| Manufacturing method | See Example 2 |
| Extrusion qualities | Adequate but with higher friction |
| | and heat |
| Water injection required for pasta | 50-60% (w/w) |
| dough formation | |
| Taste and texture | Very good |
| Acid stability | Good (+58% change) |

Nutritional Information of Formulation B per 100 g serving

| | | |
|---|---|---|
| Protein | 61 | g |
| Total Carbohydrate | 25 | g |
| Fiber | 4 | g |
| Fat | 4 | g |
| Calories | 364 | calories |

Formulation C

This formulation illustrates a composition made with 1.5 times more fat than example B and made without buffering agents.

Formulation C comprised the following components:

| Ingredient | % by weight |
|---|---|
| Soy Protein (Nutriant Iso III) | 45.455 |
| Soy Flour (Nutriant Standard Flour S120) | 20.20 |
| Semolina Flour (Antoine's Pasta Flour) | 20.202 |
| Wheat gluten isolate (MGP Arise 6000) | 14.141 |

Results of Formulation C

| | |
|---|---|
| Manufacturing method | See Example 2 |
| Extrusion qualities | Good in low temperature, low |
| | shear pasta extrusion |
| Water injection required for pasta dough | 40-60% (w/w) |
| formation | |
| Taste and texture | Very good |
| Acid stability | Good (+42% change) |

Nutritional Information of Formulation C per 100 g serving

| | | |
|---|---|---|
| Protein | 59 | g |
| Total Carbohydrate | 27 | g |
| Fiber | 4 | g |
| Fat | 6 | g |
| Calories | 381 | calories |

Formulation D

This formulation illustrates a fat-containing soy noodle.

Formulation D comprised the following components:

| Ingredient | % by weight |
|---|---|
| Soy Protein (Nutriant Iso III) | 55 |
| Soy Flour (Nutriant Standard Flour S120) | 30 |
| Wheat gluten isolate (MGP Arise 6000) | 15 |

Results of Formulation D

| | |
|---|---|
| Manufacturing method | See Example 2 |
| Extrusion qualities | Very feasible, yet temperamental |
| | extrusion qualities, fragile noodle not |
| | suited for long goods |
| Water injection required for pasta | ˜55% (w/w) |
| dough formation | |
| Taste and texture | Good |
| Acid stability | Not good (+282% change) |

Nutritional Information of Formulation D per 100 g serving

| | | |
|---|---|---|
| Protein | 69 | g |
| Total Carbohydrate | 13 | g |
| Fiber | 6 | g |
| Fat | 8 | g |
| Calories | 375 | calories |

Formulation E

This formulation illustrates a fat free soy noodle.

Formulation E comprised the following components:

| Ingredient | % by weight |
|---|---|
| Soy Protein (ADM Profam 974) | 55 |
| Soy Flour (Nutriant Standard Flour S120) | 30 |
| Wheat gluten isolate (MGP Arise 6000) | 15 |

Results of Formulation E

| | |
|---|---|
| Manufacturing method | See Example 2 |
| Extrusion qualities | Very feasible, yet temperamental |
| | extrusion qualities; tends to extrude hot; |
| | difficult to form glutenous noodle dough |
| | without being too dry, firm or sticky |
| Water injection required for | ˜55% (w/w) |
| pasta dough formation | |
| Taste and texture | Good |
| Acid stability | Not good (+275% change) |

Nutritional Information of Formulation E per 100 g serving

| | | |
|---|---|---|
| Protein | 73 | g |
| Total Carbohydrate | 11 | g |
| Fiber | 6 | g |
| Fat | 5 | g |
| Calories | 359 | calories |

Formulation F

This formulation illustrates a preferred soy noodle with emulsified fat and buffer salts having low total carbohydrate and good eating texture in neutral pH applications.

Formulation F comprised the following components:

| Ingredient | % by weight |
|---|---|
| Soy Protein containing fat (Nutriant Iso III) | 54.455 |
| Soy Flour (Nutriant Standard Flour S120) | 29.703 |
| Wheat gluten isolate (MGP Arise 6000) | 14.851 |
| Sodium Citrate | 0.5 |
| Disodium phosphate | 0.5 |

Results of Formulation F

| | |
|---|---|
| Manufacturing method | See Example 2 |
| Extrusion qualities | Okay in low temperature, low shear |
| | extrusion |
| Water injection required for pasta | 50-60% (w/w) |
| dough formation | |
| Taste and texture | Good |
| Acid stability | Poor (+153% change) |

Nutritional Information of Formulation F per 100 g serving

| | | |
|---|---|---|
| Protein | 69 | g |
| Total Carbohydrate | 13 | g |
| Fiber | 6 | g |
| Fat | 5 | g |
| Calories | 371 | calories |

Formulation G

This formulation illustrates a fat-containing soy noodle with buffer and soy protein selected to show equivalences. The cream powder adds enough fat to set the total fat content equal to Formulation F.

Formulation G comprised the following components:

| Ingredient | % by weight |
|---|---|
| Soy Protein (ADM Profam 974) | 45.455 |
| Soy Flour (Nutriant Standard Flour S120) | 29.703 |
| Cream Powder (Kerry Kerrykreem 260) | 9.00 |
| Wheat gluten isolate (MGP Arise 6000) | 14.851 |
| Sodium Citrate | 0.5 |
| Disodium phosphate | 0.5 |

Results of Formulation G

| | |
|---|---|
| Manufacturing method | See Example 2 |
| Extrusion qualities | Good, but fragile noodles that may be |
| | more difficult to use in long goods. |
| Water injection required for pasta | 50-60% (w/w) |
| dough formation | |
| Taste and texture | Good |
| Acid stability | Poor (+169% change) |

Nutritional Information of Formulation G per 100 g serving

| | | |
|---|---|---|
| Protein | 64 | g |
| Total Carbohydrate | 14 | g |
| Fiber | 6 | g |
| Fat | 9 | g |
| Calories | 376 | calories |

Formulation H

This formulation illustrates a fat free composition made with buffer salts. This is shown only as an example of a negative control.

Formulation H comprised the following components:

| Ingredient | % by weight |
|---|---|
| Soy Protein (ADM Profam 974) | 54 |
| Soy Flour (Nutriant Standard Flour S120) | 30 |
| Wheat gluten isolate (MGP Arise 6000) | 15 |
| Sodium Citrate | 0.5 |
| Disodium phosphate | 0.5 |

Results of Formulation H

| | |
|---|---|
| Manufacturing method | See Example 2 |
| Extrusion qualities | Good in low temperature with tendency |
| | toward higher friction |
| Water injection required for | 50-60% (w/w) |
| pasta dough formation | |
| Taste and texture | Good |
| Acid stability | Poor (+284% change) |

Nutritional Information of Formulation H per 100 g serving

| | | |
|---|---|---|
| Protein | 72 | g |
| Total Carbohydrate | 11 | g |
| Fiber | 6 | g |
| Fat | 5 | g |
| Calories | 355 | calories |

Formulation I

This formulation illustrates a low carbohydrate pasta with finely emulsified fat.

Formulation I comprised the following components:

| Ingredient | % by weight |
|---|---|
| Soy Protein (ADM Profam 974) | 45.455 |
| Soy Flour (Nutriant Standard Flour S120) | 30.303 |
| Wheat gluten isolate (MGP Arise 6000) | 15.152 |
| Kerrykreem 260 | 9.090 |

Results of Formulation I

| | |
|---|---|
| Manufacturing method | See Example 2 |
| Extrusion qualities | Good in low temperature, low shear pasta |
| | extrusion |
| Water injection required for | 40-60% (w/w) |
| pasta dough formation | |
| Taste and texture | Good; tends toward softer noodle |
| Acid stability | Good (+64% change) |

Nutritional Information of Formulation I per 100 g serving

| | | |
|---|---|---|
| Protein | 65 | g |
| Total Carbohydrate | 14 | g |
| Fiber | 6 | g |
| Fat | 9 | g |
| Calories | 379 | calories |

Formulation J

This formulation illustrates a pasta comprises a mixture of milk and soy proteins. This example is shown as a negative control for textural analysis when compared to the formulations that contain starch or fats.

Formulation J comprised of the following components:

| Ingredient | % by weight |
|---|---|
| Soy Protein (ADM Profam 974) | 27.5 |
| Ultranor Milk Protein Isolate 9060 (Kerry) | 27.5 |
| Soy Flour (Nutriant Standard Flour S120) | 30 |
| Wheat gluten isolate (MGP Arise 6000) | 15 |

Results of Formulation J

| | |
|---|---|
| Manufacturing method | See Example 2 |
| Extrusion qualities | Exceptional in low temperature, low shear |
| | pasta extrusion |
| Water injection required for | 60% (w/w) |
| pasta dough formation | |
| Taste and texture | Good taste; softer texture |
| Acid stability | Poor (+320% change) |

Nutritional Information of Formulation J per 100 g serving

| | | |
|---|---|---|
| Protein | 75 | g |
| Total Carbohydrate | 11 | g |
| Fiber | 6 | g |
| Fat | 4 | g |
| Calories | 358 | calories |

Formulation K

This formulation illustrates a milk and soy noodle made with acid stability enhancing ingredients.

Formulation K comprised of the following components:

| Ingredient | % by weight |
|---|---|
| Soy Protein (ADM Profam 974) | 19 |
| Ultranor Milk Protein Isolate 9060 (Kerry) | 19 |
| Soy Flour (Nutriant Standard Flour S120) | 20 |
| Wheat gluten isolate (MGP Arise 6000) | 15 |
| Cream Powder (Kerry Kerrykreem 260) | 6 |
| Sodium Citrate | 0.5 |
| Disodium phosphate | 0.5 |
| Semolina Flour (Antoine's Pasta Flour) | 20 |

Results of Formulation K

| | |
|---|---|
| Manufacturing method | See Example 2 |
| Extrusion qualities | Exceptional in low temperature, |
| | low shear pasta extrusion |
| Water injection required for | 40-60% (w/w) |
| pasta dough formation | |
| Taste and texture | Good taste; softer texture |
| Acid stability | Good (+37% change) |

Nutritional Information of Formulation K per 100 g serving

| | | |
|---|---|---|
| Protein | 58 | g |
| Total Carbohydrate | 27 | g |
| Fiber | 4 | g |
| Fat | 6 | g |
| Calories | 377 | calories |

Formulation L

This formulation illustrates a fat free composition made with semolina flour.

Formulation L comprised the following components:

| Ingredient | % by weight |
|---|---|
| Soy Protein (ADM Profam 974) | 45 |
| Soy Flour (Nutriant Standard Flour S120) | 21 |
| Wheat gluten isolate (MGP Arise 6000) | 14 |
| Semolina Flour (Antoine's Pasta Flour) | 20 |

Results of Formulation L

| | |
|---|---|
| Manufacturing method | See Example 2 |
| Extrusion qualities | Good in low temperature, low |
| | shear pasta extrusion |
| Water injection required for | 50-60% (w/w) |
| pasta dough formation | |
| Taste and texture | Good taste and ok texture - some |
| | tooth stick in bite release |
| Acid stability | Good (+33% change) |

Nutritional Information of Formulation L per 100 g serving

| | | |
|---|---|---|
| Protein | 62 | g |
| Total Carbohydrate | 25 | g |
| Fiber | 4 | g |
| Fat | 4 | g |
| Calories | 367 | calories |

Formulation M

This formulation illustrates a preferred embodiment having very low carbohydrate content.

Formulation M comprised the following components:

| Ingredient | % by weight |
|---|---|
| Soy Protein (ADM Profam 974) | 47 |
| Soy Protein Concentrate (Kerry Nutriant S700) | 25 |
| Wheat gluten isolate (MGP Arise 6000) | 18 |
| Cream Powder (Kerry Kerrykreem 260) | 10 |

Results of Formulation M

| | |
|---|---|
| Manufacturing method | See Example 2 |
| Extrusion qualities | Good in low temperature; low shear. |
| | Dough not well-suited for fancy die |
| | shapes. |
| Water injection required for | 60% (w/w) |
| pasta dough formation | |
| Taste and texture | Good |
| Acid stability | Poor (+200% change) |

Nutritional Information of Formulation M per 100 g serving

| | | |
|---|---|---|
| Protein | 72 | g |
| Total Carbohydrate | 12 | g |
| Fiber | 7 | g |
| Fat | 8 | g |
| Calories | 383 | calories |

Formulation N

This illustrates a preferred embodiment for rice like pasta (orzo/riso).

Formulation N comprised the following components:

| Ingredient | % by weight |
|---|---|
| Soy Protein Concentrate (Kerry Nutriant S700) | 27 |
| Soy Protein containing fat (Nutriant Iso III) | 27 |
| Soy Flour (Nutriant Standard Flour S120) | 28 |
| Wheat gluten isolate (MGP Arise 6000) | 18 |

Nutritional Information of Formulation N per 100 g serving

| | |
|---|---|
| Protein | 68 g |
| Total Carbohydrate | 15.5 g |
| Fiber | 9.5 g |
| Fat | 5.2 g |
| Calories | 343 calories |

Results: Pasta was manufactured in accordance with Examples 1 and 2. The pasta had a texture that was very similar to rice when formed and dried in a rice like shape. Titanium dioxide (0.1%) could be added to give the product a more white appearance. The rice pasta was cooked by bringing two volumes of water to a boil and adding one volume rice pasta and removing from heat. In 15 minutes, the pasta had absorbed most of the water and had a rice like texture.

### Example 5

This example illustrates a method of comparing the texture of different pastas.

The AACC method 16-50 Pasta Cooking Quality—Firmness was used to work with a TAXT2 texture analyzer by Texture Technologies Corp of Scarsdale New York. Linguine noodles were extruded through a die 0.034″ by 0.180″. The noodles were first dried, then boiled in water for 14 minutes, drained and tossed in an ice water bath until testing. Five strands of each pasta were arranged in straight rows on a metal plate. A rectangular metal tooth 0.125″×2.750″ was set to bite across all five noodles. The minimum force in grams required to bite through the strands was recorded, as well as the force required to lift the tooth, referred to as the tooth stick force, was measured (Table 1). Tests were repeated at least 3 times and averages were taken. Because protein texture changes near the protein isoelectric point, and because typical tomato based sauces are near the isoelectric point of soy protein, testing was done on neutral and acidified noodles. To acidify the noodles, 10 g of noodles were allowed to equilibrate in 1 liter of 1.2% lactic acid for 5 to 10 minutes prior to testing.

TABLE 1

| | | | | | Minimum Peak | | Tooth Stick | |
|---|---|---|---|---|---|---|---|---|
| | | | | | Bite Force (g) | | Force (g) | |
| Formulation | Fat | Buffer | Semolina | Protein | Neutral | Acidic | Neutral | Acidic |
| A | Y | Y | Y | 1 | 813 | 1043 | 24 | 158 |
| B | N | Y | Y | 2 | 791 | 1252 | 63 | 114 |
| C | Y | N | Y | 1 | 840 | 1191 | 51 | 127 |
| D | Y | N | N | 1 | 341 | 1302 | 75 | 346 |
| E | N | N | N | 2 | 102 | 381 | 28 | 117 |
| F | Y | Y | N | 1 | 321 | 810 | 96 | 223 |
| G | Y | Y | N | 2 | 311 | 837 | 43 | 131 |
| H | N | Y | N | 2 | 197 | 756 | 52 | 187 |
| I | Y | N | N | 2 | 314 | 515 | 53 | 132 |
| J | N | N | N | 3 | 316 | 1326 | 94 | 154 |
| K | Y | Y | Y | 3 | 248 | 340 | 36 | 78 |
| L | N | N | Y | 2 | 737 | 986 | 55 | 103 |
| M | Y | N | Y | 2 | 432 | 866 | 81 | 160 |
| Semolina | | | | | 696 | 542 | 29 | 29 |

Sensory Descriptions of Texure Analysis Values

| | Peak Bite Force | | Tooth Stick |
|---|---|---|---|
| Undercooked | More than 1100 | g | Less than 100 g good |
| Al Dente | 900-1100 | g | |
| Firm | 800-900 | g | ˜150 g noticeable |
| Medium | 600-800 | g | |
| Tender | 400-600 | g | ˜200+ g poor |
| Soft | 300-400 | g | Tacky/Sticky defect |
| Mushy | Less than 300 | g | |

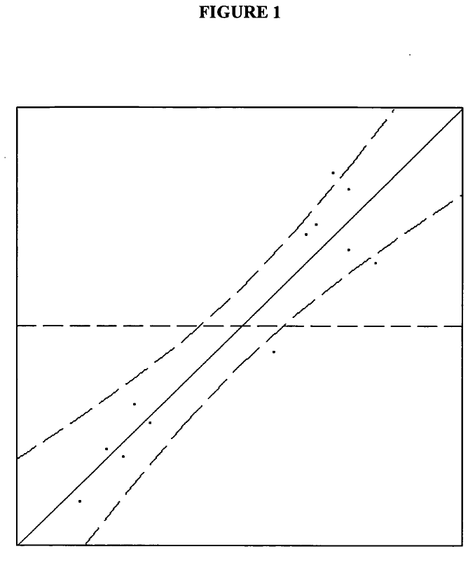

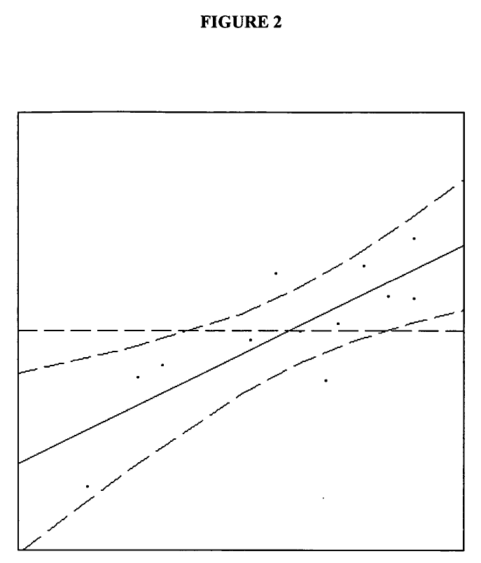

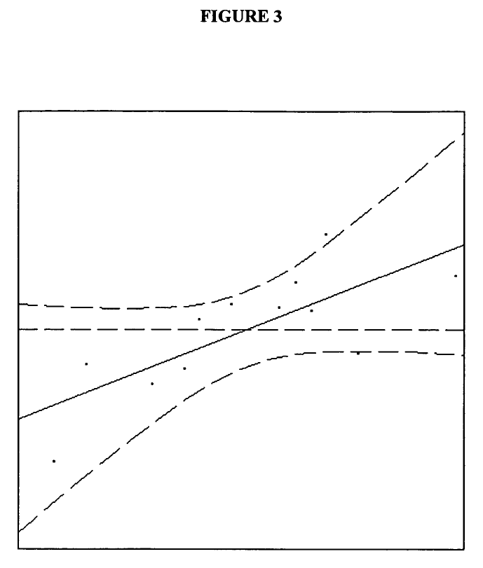

Least squares mean analysis was done on the above data with an emphasis on effect leverage (Table 2). Acid stability (or ratio of acid minimum peak bite & break force to neutral minimum peak bite & break force) was improved by the addition of semolina by 280% (P=0.0005). Protein selection changed acid stability by as much as 160% (P=0.0760) and presence of finely emulsified fat by 180% (p=0.0151). Buffer salts, while not shown to have a significant effect in this test when their buffering capacity was exhausted, did on average improve acid stability with respect to peak bite force and tooth stick, and had quite dramatic effects when buffering actively. FIG. 1 shows with an extraordinary degree of confidence that the presence of 20% semolina flour enhances textural stability in acid and neutral conditions. Mean values for textural stability near 1 are considered ideal. FIG. 2 shows with great confidence that the presence of 4% or more emulsified fat enhances textural stability in acid and neutral conditions. FIG. 3 shows with considerable confidence that the choice of globular protein (ADM Profam 974, Kerry Nutriant Iso III or a mix of ADM Profam 974 and Kerry Milk Protein Isolate 9060) has a considerable effect on acid stability.

TABLE 2

Least square mean

| | | |
|---|---|---|
| Semolina leverage plot | Absent | 3.89 |
| (FIG. 1) | Present | 1.36 |
| Emulsified fat leverage plot | Absent | 3.40 |
| (FIG. 2) | Present | 1.85 |
| Protein choice leverage plot | ADM | 1.84 |
| (FIG. 3) | Profam 947 | |
| | Kerry | 3.06 |
| | Nutriant ISO | |
| | III | |
| | Mix of both | 2.99 |

### Example 6

This example illustrates more formulations of the present invention.

Formulation O

| Ingredient | % by weight |
|---|---|
| Soy Protein containing Fat (Nutriant Iso III) | 45 |
| Semolina (Wheat flour) | 20 |
| Soy Flour (Nutriant STD 20-40) | 20 |
| Modified Wheat Gluten (MGP Arise 5000) | 14 |
| Dicalcium Phosphate | 0.5 |
| Sodium Citrate | 0.5 |

| Nutritional Info: | % wt/wt | Per 56 g (2 oz) Serving |
|---|---|---|
| Protein | 59 | 33.1 g |
| Total Carb | 25 | 14.2 g |
| Fiber | 3 | 1.6 g |
| Fat | 6 | 3.3 g |

Formulation O was used to make pasta in accordance with Example 2. Water was added at approximately a 40-50% wt/wt ratio. Formulation O took 1-2 minutes longer than a traditional semolina pasta to boil, and resulted in a product that was nearly identical to traditional semolina in sensory testing.

Formulation P

This formulation illustrates a formulation having an alternate source of soy protein isolate. Also, this formulation results in a rapid-cook composition.

| Ingredient | % by weight |
|---|---|
| Soy Protein (ADM Profam 974) | 45 |
| Semolina (Wheat flour) | 18 |
| Soy Flour (Nutriant STD 20-40) | 18 |
| Modified Wheat Gluten (MGP Arise | 11 |
| 5000) | |
| Encapsulated Soy Oil (Kerry Kreamer | 8 |
| 260) | |
| Dicalcium Phosphate | 0.5 |
| Sodium Citrate | 0.5 |

| Nutritional Info: | % wt/wt | Per 56 g (2 oz) Serving |
|---|---|---|
| Protein | 55 | 30.6 g |
| Total Carb | 26 | 14.6 g |
| Fiber | 3 | 1.5 g |
| Fat | 10 | 5.3 g |

Formulation P was used to make pasta in accordance with Example 2. Water was added at approximately a 40% wt/wt ratio. Because of the low gluten content, the product was somewhat more difficult to manufacture than Formulation O. Because of the low gluten content, this pasta cooked more rapidly than Formulation O. It also was very similar to semolina in sensory testing.

Formulation Q

This formulation illustrates a low carbohydrate blend.

| Ingredient | % by weight |
|---|---|
| Organic Soy Isolate (Nutriant ISO III) | 50 |
| Soy Flour (Nutriant STD 20-40) | 30 |
| Mod. Wheat Gluten (MGP Arise 5000) | 18 |
| Salt | 1 |
| Dicalcium Phosphate | 0.5 |
| Sodium Citrate | 0.5 |

| Nutritional Info: | % wt/wt | Per 56 g (2 oz) Serving |
|---|---|---|
| Protein | 69 | 38.4 g |
| Total Carb | 12 | 6.4 g |
| Fiber | 4 | 2.4 g |
| Fat | 7 | 4.0 g |

Formulation Q was used to make pasta in accordance with Example 2. Water was added at approximately a 50-55% wt/wt ratio. It had a mild taste similar to semolina, but because of its high gluten content and low carbohydrate content, it resulted in a firm noodle that consumers may find undesirable. This pasta took 4-6 minutes longer than a traditional semolina based boil up profile.

Formulation R

This formulation illustrates a pasta that is suitable for red sauce, i.e., acid stable.

| Ingredient | % by weight |
|---|---|
| Soy Protein containing Fat (Nutriant Iso III) | 50 |
| Nutriant - Organic soy flour (20/40 PDI) | 30 |
| MGP - Wheat gluten isolate - Arise 6000 | 18 |
| Salt (Sodium Chloride) | 1 |
| Dicalcium Phosphate Dihydrate | 0.5 |
| Trisodium Citrate | 0.5 |

Nutritional Information per 56 g serving

| | |
|---|---|
| Protein | 38 g |
| Total Carbohydrate | 6.4 g |
| Fiber | 2.4 g |
| Fat | 4.8 g |

Traditional pasta making methods were employed on this dry blend to create a protein pasta. Both single-screw and twin-screw extruders were suitable for making the pasta, as was a conventional kitchen method. The protein pasta dry blend was compatible with existing pasta production lines. The water content in this protein pasta was higher, the extrusion temperature profile was a little higher, and the drying of the pasta may be more aggressive. In a conventional kitchen method, water (350 ml) was added to 600 grams of dry blend. The dough was kneaded for 2 minutes and water was added as needed to form a dough mass. The dough was then rolled into a flat sheet and cut into long noodles. The noodles were then air dred on a rack for 30 minutes for use as a fresh pasta or 24 hours as a dry pasta. For fresh pasta, the pasta was cooked for ˜4 minutes in boiling water. For dry pasta, the pasta was cooked for ˜15 minutes in boiling water.

In a single-screw extruder method, warm water (120° F.) was added to the dry blend at 40-50% by weight and kneaded into a dough mass under vacuum (−25 mmHg). The dough was then fed into a single-screw extruder, which pushed the dough through a set of dies. Dough exiting the die was between 100° F.-211° F. A cutter was employed for short goods (e.g., elbow macaroni or rotini), or the pasta was hung over rods for long goods (e.g., spaghetti or linguini).

For a twin-screw extruder method, the dry blend and water was metered into the twin-screw extruder to form a 40% moisture dough. Steam injection was substituted for cold water, at a lower moisture level. The extruder was configured to consist of a hot (80° C.) short mixing zone followed by a long cooling forward screw (30° C.) zone, with the last couple of elements being single lead screws. The dough was forced out through dies by the single lead screws and cut into short or long goods.

The protein pasta was dried much like traditional semolina pasta. The protein pasta was dried for 5 hours at 55° C. and 85% relative humidity, then 5 more hours at 73° C. and 80% relative humidity, and finally 2 hours ramping down to 40° C. and 50% relative humidity. Alternatively, protein pasta long goods were hung and dried under ambient conditions (70° F., 50% RH) over 24 hours. Rapid drying of protein pasta short goods pasta was also accomplished at 250° F. for 15 minutes.

The finished dry pasta was treated much like a traditional pasta by consumers. Thin walled elbow macaroni was boiled for 6-8 minutes, while thicker products like linguini were boiled for 12 minutes (for al dente) to 14 minutes. Boiled pasta may be rinsed and tossed with olive oil or butter to prevent drying.

With respect to Formulation R, the soy protein isolate and soy flour replaced starch. Nutriant products did not have to be used, although this particular formulation is optimized for their inclusion. The soy gave the protein pasta a smooth texture typical of pasta—quite unlike the mealy texture common in high fiber formulations. The wheat gluten isolate helped hold the pasta together and gave it the characteristic bite of semolina pasta. The last three ingredients may be considered optional. The salt improved the flavor and increased boil up stability. The soy protein did not curdle in cream, butter or cheese based sauces, but could in acidic tomato sauces. The dicalcium phospate and sodium citrate enhanced texture stability under acidic conditions and prevented the soy proteins from curding.

Formulation S

This formulation illustrates a food composition suitable for making a rice substitute.

| Ingredient | % by weight |
|---|---|
| Nutriant - Soy protein concentrate (S700) | 40 |
| Nutriant - Soy flour (20/40 PDI) | 40 |
| MGP - Wheat gluten isolate - Arise 6000 | 18 |
| Salt (Sodium Chloride) | 2 |

Nutritional Information per 56 g dry serving

| | |
|---|---|
| Protein | 34 g |
| Total Carbohydrate | 11.2 g |
| Fiber | 7.7 g |
| Fat | 2.4 g |

The pasta resulting from Formulation S was made in accordance with Example 1. The soy protein concentrate used in this food composition contained more dietary fiber than soy protein isolate, such that the fiber content was increased and the resulting rice substitute pasta had a firm rice-like texture. The soy protein concentrate and soy flour replaced starch. Vital wheat gluten was used to bind the product together. Salt was added for taste.

This rice shaped protein pasta was manufactured employing the methods outlined for Formulation R. A special die and higher speed cutter was used to make rice shaped pasta, which was subsequently rapidly dried in a fluid bed at 210° F. The rice shaped protein pasta was then cooked by adding the dry pasta to boiling water for 15-20 minutes. The rice shaped pasta was rinsed and thoroughly drained prior to serving. The cooked rice shaped protein pasta can be stir fried. A rice shaped pasta die and increased fiber content gave this product an appearance and texture that was similar to rice, but different in that it comprised mostly protein. This rice-like pasta can be used as a substitute for rice, and even works in applications like “fried rice” or “sizzling rice soup.”

Formulation T

This formulation illustrates rapid-cook pasta. Specifically, it represents a salt free dry blend with reduced gluten content that can be extruded through thin dies to produce a dry pasta that will quickly cook up.

| Ingredient | % by weight |
|---|---|
| Soy Protein containing Fat (Nutriant Iso III) | 56.8 |
| Soy flour (20/40 PDI) | 27.8 |
| MGP - Wheat Gluten Isolate - Arise 6000 | 15.4 |

Nutritional Information per 56 g dry serving

| | |
|---|---|
| Protein | 39 g |
| Total Carbohydrate | 6.2 g |
| Fiber | 2.2 g |
| Fat | 5.2 g |

The pasta resulting from Formulation T was made in accordance with Examples 1 and 2. The soy protein isolate and soy flour replaced the starch that is typically found in a common semolina pasta, while the wheat gluten isolate bound the product together. Processing was similar to Formulation R. Thinly walled dies were used to make a pasta that picks up water more rapidly. Boil dry finished thin pasta 3-5 minutes. Drain and serve. As a thin walled elbow macaroni, this product would be ideal in a cheese sauce. In the presence of salted water, this pasta cooked up more slowly, although it may also be used in instant soup with a cook time of five minutes or more. This particular pasta formulation is not well suited for acidic tomato sauces. In acidic conditions, the noodles will curdle resulting in a short rubbery texture, or even a squeaky bite like fresh cheese curds.

Formulation U

This formulation illustrates a low fiber soy milk pasta.

Formulation U comprised the following components:

| Ingredient | % by weight |
|---|---|
| Low Fiber Soy Milk (Nutriant 27200-18A) | 65% |
| Wheat gluten isolate (MGP Arise 6000) | 15% |
| Semolina Flour (Antoine's Pasta Flour) | 20% |

Results of Formulation U

| | |
|---|---|
| Manufacturing method | See Example 2 |
| Extrusion qualities | Good extrusion qualities in low |
| | temperature, low shear pasta |
| | extrusion |
| Water injection required for pasta | ˜50% (w/w) |
| dough formation | |
| Taste and texture | A very mild green-soy milk taste |
| | after cooking and had a traditional |
| | texture |
| Acid stability | +36% change |

Nutritional Information of Formulation U per 100 g of dry formula

| | |
|---|---|
| Protein | 49.7 g |
| Total Carbohydrate | 23.6 g |
| Fiber | 6.0 g |
| Fat | 10.7 |
| Calories | 366 calories |

All references, including publications, patent applications, and patents, cited herein are hereby incorporated by reference to the same extent as if each reference were individually and specifically indicated to be incorporated by reference and were set forth in its entirety herein.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A pasta comprising, by weight, at least about 55% protein, about 10% or less fiber, and at least about 4% fat.

2. The pasta of claim 1, comprising less than about 30% total carbohydrate by weight.

3. The pasta of claim 2, comprising less than about 15% total carbohydrate by weight.

4. The pasta of claim 1, comprising, by weight, about 55%-75% protein, about 10-30% total carbohydrate, about 3-10% fiber, and about 4-10% fat.

5. The pasta of claim 4, comprising, by weight, about 58% protein, about 27% total carbohydrate, about 4% fiber, and about 6% fat.

6. The pasta of claim 4, comprising, by weight, about 69% protein, about 13% total carbohydrate, about 6% fiber, and about 5% fat.

7. The pasta of claim 4, comprising, by weight, about 72% protein, about 12% total carbohydrate, about 7% fiber, and about 8% fat.

8. The pasta of claim 1, wherein the pasta is a rice substitute.

9. The pasta of claim 8, comprising, by weight, at least about 65% protein and less than about 20% total carbohydrate.

10. The pasta of claim 9, comprising, by weight, about 65% protein, about 14% total carbohydrate, about 6% fiber, and about 7% fat.

11. The pasta of claim 9, comprising, by weight, about 68% protein, about 16% total carbohydrate, about 10% fiber, and about 5% fat.

12. The pasta of claim 1, wherein the pasta is a gluten-free pasta.

13. The pasta of claim 12, wherein the gluten-free pasta comprises, by weight, at least about 75% protein and less than about 10% total carbohydrate.

14. The pasta of claim 13, comprising about 80% protein by weight, about 7% total carbohydrate, less than about 5% fiber, and about 7% fat.

15. The pasta of claim 1, wherein the pasta is a rapid-cook pasta.

16. The pasta of claim 15, wherein the rapid-cook pasta comprises, by weight, about 55% or more protein and less than about 30% total carbohydrate.

17. The pasta of claim 16, wherein the rapid-cook pasta comprises, by weight, about 55-70% protein, about 10-30% total carbohydrate, about 3-6% fiber, and about 6-10% fat.

18. The pasta of claim 17, comprising, by weight, about 55% protein, 26% total carbohydrate, about 3% fiber, and about 10% fat.

19. The pasta of claim 17, comprising, by weight, about 70% protein, about 11% total carbohydrate, about 4% fiber, and about 9% fat.

20. A pasta having at least about 55% protein, by weight, and having a firmness value that does not differ by more than 40% from that of 100% durum semolina wheat pasta.

21. A food composition comprising, by weight, (i) about 10-20% glutinous protein, (ii) about 35-80% globular protein, (iii) starch, fat, or a combination thereof, and, optionally, (iv) buffering agent.

22. The food composition of claim 21, wherein the glutinous protein is a casein protein or a protein derived from a cereal grain.

23. The food composition of claim 22, wherein the protein derived from a cereal grain is a wheat gluten.

24. The food composition of claim 21, wherein the globular protein is a soy protein.

25. The food composition of claim 21, wherein the fat is a finely divided fat, an emulsified fat, or a combination thereof.

26. The food composition of claim 25, wherein the fat is selected from the group consisting of an encapsulated spray-dried fat, an emulsified plastic shortening, a protein-bound oil, and combinations thereof.

27. The food composition of claim 21, wherein the buffering agent is selected from the group consisting of lysine, a citrate salt, a phosphate salt, an ethylendiamminetetraacetic acid, a TRIS buffer, a lactate salt, an ascorbate salt, a carbonate salt, a salt of a long chain fatty acid, and combinations thereof.

28. The food composition of claim 27, wherein the buffering agent comprises a citrate salt and a phosphate salt.

29. The food composition of claim 28, wherein the citrate salt is sodium citrate and the phosphate salt is dicalcium phosphate.

30. The food composition of claim 21, wherein the starch is a flour.

31. The food composition of claim 30, wherein the flour is a wheat flour, a corn flour, a potato flour, a rice flour, or a tapioca flour.

32. The food composition of claim 21, comprising, by weight, about 5-55% starch, about 4% or more fat, or a combination thereof.

33. The food composition of claim 32, comprising by weight, about 8-30% starch, about 4-16% fat, or a combination thereof.

34. The food composition of claim 33, comprising, by weight, about 10-20% starch.

35. The food composition of claim 32, comprising, by weight, about 10-20% wheat gluten, about 35-80% globular protein, about 0-1% dicalcium phosphate, and about 0-1% sodium citrate.

36. The food composition of claim 35, comprising, by weight, about 45% soy protein, about 20% soy flour, about 20% semolina flour, about 14% wheat gluten isolate, about 0.5% sodium citrate, and about 0.5% disodium phosphate.

37. The food composition of claim 35, comprising, by weight, about 54% soy protein, about 30% soy flour, about 15% wheat gluten isolate, about 0.5% sodium citrate, and about 0.5% disodium phosphate.

38. The food composition of claim 35, comprising, by weight, about 47% soy protein, about 25% soy protein concentrate, about 18% wheat gluten isolate, and about 10% cream powder.

39. The food composition of claim 35, comprising, by weight, about 44% soy isolate, about 18% soy flour, about 11% wheat gluten isolate, about 0.5% dicalcium phosphate, about 0.5% sodium citrate, about 8% soy oil, and about 18% wheat flour.

40. The food composition of claim 21, comprising, by weight, about 57% soy protein isolate, about 28% soy flour, and about 15% wheat gluten isolate.

41. The food composition of claim 21, comprising, by weight, about 25%-50% soy protein, about 25%-50% soy flour, and about 10%-20% wheat gluten.

42. The food composition of claim 41 comprising about 28% soy flour, about 27% soy protein, about 27% soy concentrate, and about 18% wheat isolate.

43. The food composition of claim 41, comprising, by weight, about 40% soy protein concentrate, about 40% soy flour, about 18% wheat gluten isolate, and about 2% salt.

44. The food composition of claim 41, comprising, by weight, about 30% soy flour, about 55% soy concentrate, and about 15% wheat gluten.

45. A farinaceous food product made from the food composition of claim 21.

46. The farinaceous food product of claim 45, wherein the farinaceous food product is a pasta.

47. A food composition comprising, by weight, about 60% soy protein isolate, about 20% milk protein isolate, about 20% whey protein concentrate, and, optionally, about 0.1% to 0.2% transglutaminase.

48. A farinaceous food product made from the food composition of claim 47.

49. The farinaceous food product of claim 48, wherein the. farinaceous food product is a pasta.

50. The farinaceous food product of claim 49, wherein the pasta is a gluten-free pasta.

51. A pasta made from a food composition comprising soy milk powder.

52. The pasta of claim 51, wherein the food composition comprises, by weight, about 40% or more soy milk powder.

53. The pasta of claim 52, wherein the food composition comprises, by weight, about 40-85% soy milk powder, 10-20% wheat gluten isolate, and about 30% or less semolina flour.

54. The pasta of claim 53, wherein the food composition comprises, by weight, about 65% soy milk, about 15% wheat gluten isolate, and about 20% semolina flour.

55. The pasta of claim 51, comprising, by weight, about 48% rotein, about 31% total carbohydrate, about 3% fiber, and about 6% fat.

56. A food composition comprising, by weight, about 40-85% soy milk powder, 10-20% wheat gluten isolate, and about 30% or less semolina flour.

57. The food composition of claim 54, comprising, by weight, about 65% soy milk, about 15% wheat gluten isolate, and about 20% semolina flour.

58. The pasta of claim 1, wherein the pasta is dried by a drying process comprising the subsequent steps of (i) drying the pasta for 5 hours at 55° C. and 85% RH, (ii) drying the pasta for 5 hours at 73° C. and 80% relative humidity (RH), and then (iii) drying the pasta for 2 hour ramp down to 40° C. at 50% RH.
